(19) United States
(12) Patent Application Publication
(10) Pub. No.: US 2005/0001732 A1
(43) Pub. Date: Jan. 6, 2005

(54) Underseat monitor

(76) Inventor: Charles M. Sweeney, Laurence Harbor, NJ (US)

Correspondence Address: DILWORTH & BARRESE, LLP, 333 EARLE OVINGTON BLVD., UNIONDALE, NY, 11553, US

(21) Appl. No.: 10/803,650

(22) Filed: Mar. 18, 2004

Related U.S. Application Data
(60) Provisional application No. 60/455,721, filed on Mar. 18, 2003.

(51) Int. Cl. G08B 21/00

(52) U.S. Cl. 340/667

(57) ABSTRACT

Disclosed herein is an underseat alarm which provides is a lightweight, self-contained device that can readily be installed on wheelchairs of various configurations. The disclosed underseat alarm provides notification to the caretaker when a wheelchair occupant leaves the wheelchair seat, allowing the caretaker to immediately attend to the occupant and minimize the possibility of injury to the occupant.

### PRIORITY

This application claims priority to a provisional application, which was filed on Mar. 18, 2003 with the U.S. Patent and Trademark Office and was assigned application Ser. No. 60/455,721, the contents of which are incorporated by reference.

### FIELD OF INVENTION

The present invention relates generally to alarms, particularly alarms that are adaptable to fit onto and monitor whether the seat of a wheelchair is occupied.

### DESCRIPTION OF THE RELATED ART

Numerous types of wheelchairs and wheelchair configurations are known in the art. For example, U.S. Pat. No. 3,903,513 to Green et al. discloses a wheelchair alarm system that is securely attached to the wheelchair frame, having interconnected sensors on the wheelchair seat and each rear wheel brake. The system of Green is designed to ensure that unattended wheelchairs are left with its brake assemblies engaged with respective rear drive wheels, to safely immobilize the chair and avoid the possibility of the chair slipping out from under a patient who is in the process of occupying the chair.

Also known in the art is the benefit of providing an alarm to notify a caretaker when a wheelchair occupant requires assistance. For example, Norton (U.S. Pat. No. 5,137,033) discloses a patient monitoring device for notifying through an alarm, a nurse or health care provider of a wet or distressed condition of a patient that involves a detecting pad for a bed or wheelchair to conduct an electric current when wet with urine.

Devices known in the art, however, have several disadvantages. Such devices fail to recognize the need to monitor a wheelchair occupant who may be of reduced mental capacity, yet are able to leave from the wheelchair, such as patients suffering from Alzheimer's disease.

### SUMMARY OF THE INVENTION

The underseat alarm of the present invention is a self-contained device that can be manufactured at a low cost, is lightweight, and can readily be installed on wheelchairs of numerous configurations.

The underseat alarm of the present invention provides notification to the caretaker when a wheelchair occupant leaves the wheelchair seat, allowing the caretaker to immediately attend to the occupant and minimize the possibility of injury to the occupant.

Further, the underseat alarm of the present, invention provides a readily accessible means for the caretaker to silence the alarm.

### BRIEF DESCRIPTION OF THE DRAWINGS

The following detailed description provides a better understanding of the invention as well as other objects and further features thereof, in which reference is made to the accompanying drawings, wherein:

FIG. 1A is a perspective view of the bottom of the monitor;

FIG. 1B is a perspective view of the top of the monitor;

FIG. 1C is a perspective view of the side of the monitor;

FIG. 2A is a perspective view of the bottom of the monitor mounted to a chair;

FIG. 2B is a top perspective view of the monitor mounted to a chair;

FIG. 3A is a perspective view of a remote on/off switch;

FIG. 3B is an enlarged perspective view of the remote on/off type switch;

FIG. 4A is a view of the underside of the monitor, with the battery compartment cover removed;

FIG. 4B is a close-up perspective view of the monitor underside, with the battery compartment cover removed;

FIG. 5A is a close-up perspective view of the side of the monitor;

FIG. 5B is a close-up perspective view of the side of the bottom portion of another embodiment of the monitor, with the battery compartment cover removed; and

FIG. 6 provides a plan view of the top and a profile view of the side of the underseat monitor.

### DETAILED DESCRIPTION OF THE PREFERRED EMBODIMENTS

The following detailed description of the invention will be made in reference to the accompanying drawings. In describing the invention, explanation of related functions or constructions known in the art are omitted for the sake of clearness in understanding the concept of the invention, to avoid obscuring the invention with unnecessary detail.

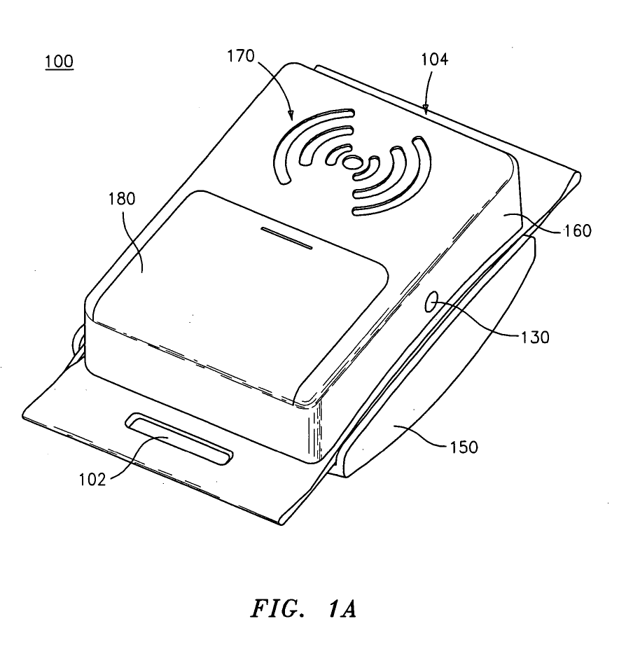

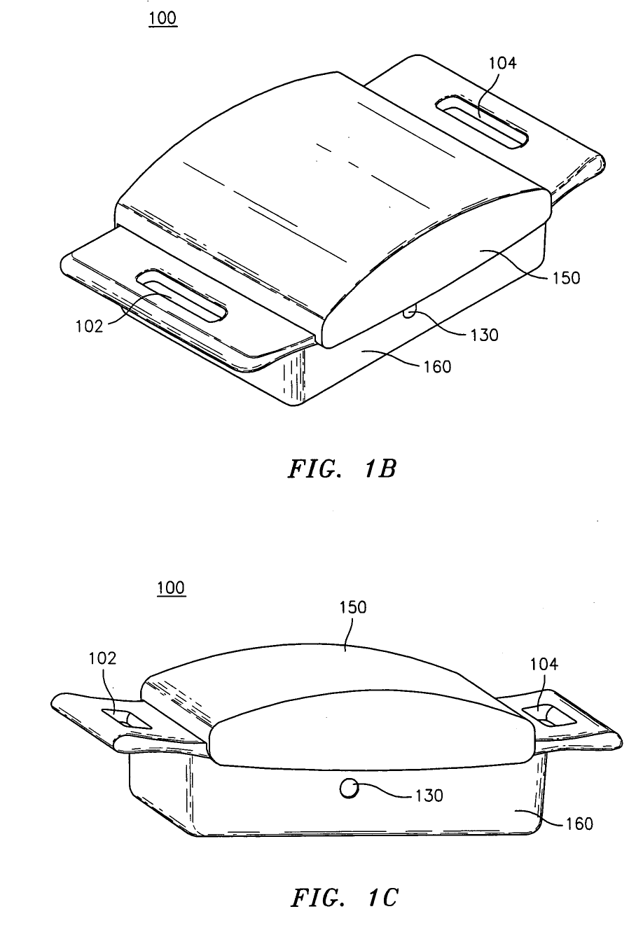

With reference to FIGS. 1A-1C, holes (102, 104) are provided opposing edges of the bottom 160 of the monitor 100, through which straps or other securing means can be threaded or affixed to set the position of the bottom 160 of the monitor 100 relative to the chair frame.

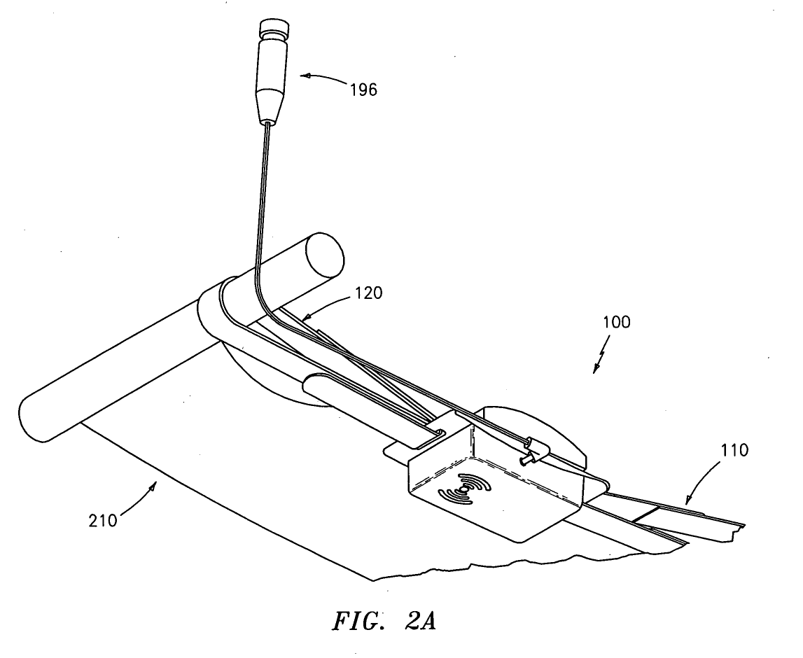

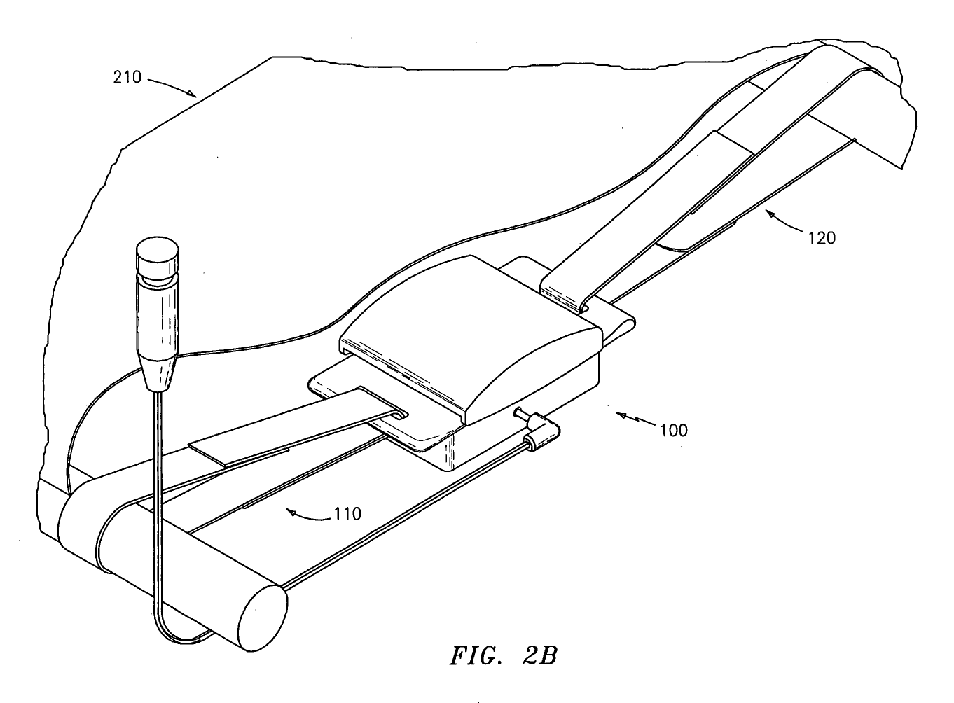

As shown in FIGS. 2A and 2B, straps 110, 120 are preferably utilized to mount the monitor 100 to the chair. Use of adjustable length straps allows the monitor to be affixed to chairs of different sizes. FIG. 2A is a perspective view of the bottom of the monitor mounted to a chair, with the seat 210 of the chair shown in partial cut-away.

The monitor 100 is positioned on the chair, via straps 110, 120, such that the top 150 of the monitor 100 contacts and slightly pushes against the underside of the seat 210 of the chair.

The bottom 160 is connected to the top 150 of the monitor in such manner that an internal spring 140 (not shown) pushes the top 150 of the monitor 100 apart from the bottom 160 of the monitor 100 by a preset distance. When sufficient force is exerted in a vertical direction, i.e. the direction that pushes the top 150 and bottom 160 closer together, the spring force is overcome and the top 150 travels the preset distance closer to the bottom 160. When the occupant rises from the seat 210, the spring force will cause the top 150 to move away from the bottom 160.

Accordingly, when the monitor 100 is positioned on the chair, such as shown in FIG. 2 and described above, the occupant sitting in the chair will create a contacting force sufficient to overcome the spring force of the internal spring 140.

The spring force also acts to hold open contacts of an internal circuit (not shown) so that the contacts of the internal circuit will close when the occupant is seated. The contacts of the internal circuit therefore open and close based on the position of the top 150 relative to the bottom 160.

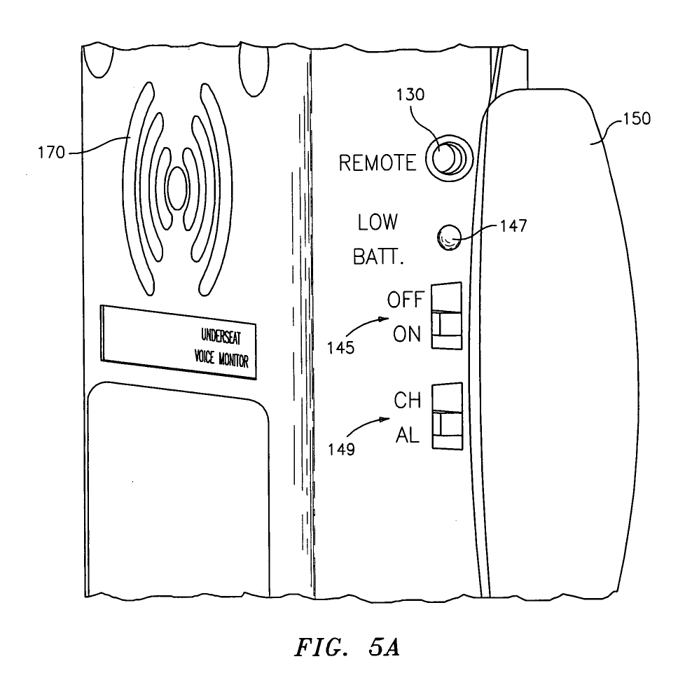

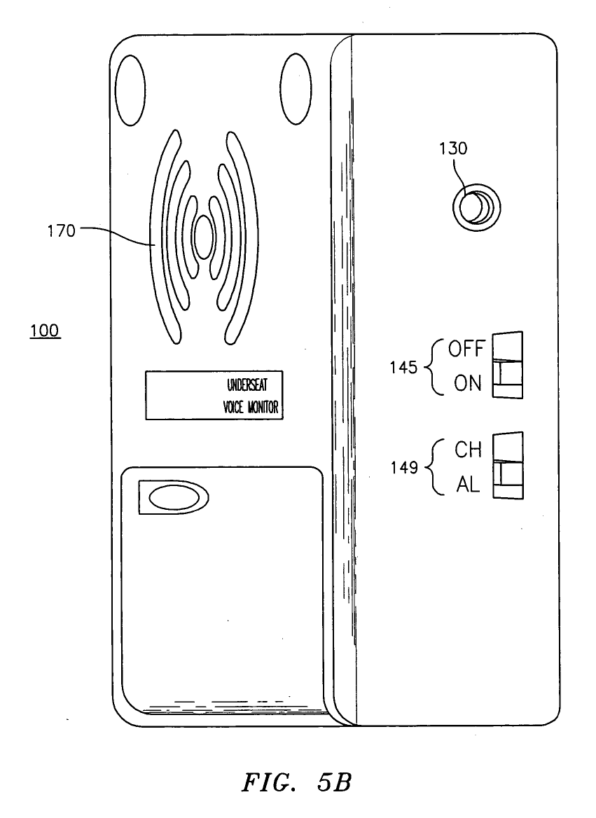

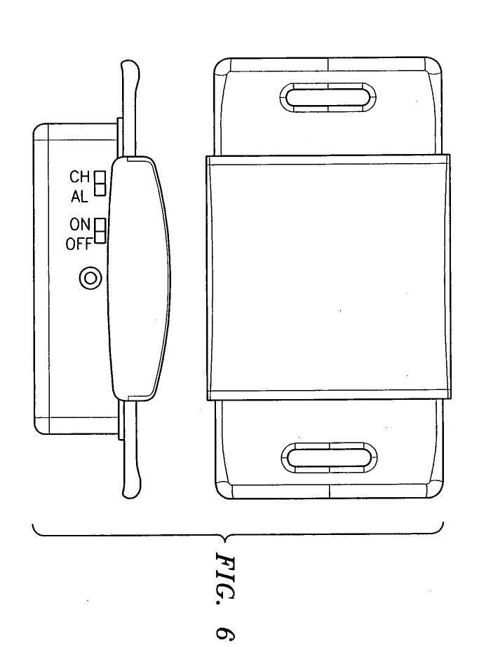

The internal circuit provides a signal to activate an alarm that is output through a speaker 170 within the monitor 100. The internal circuit preferably includes an input such as a local on/off switch 145 (see FIG. 5a) that allows the caretaker to turn on the monitor 100.

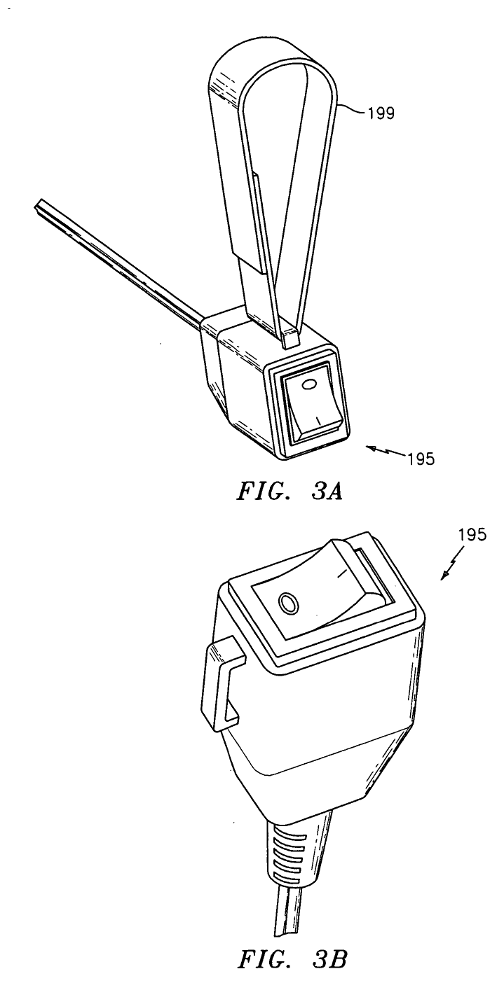

FIGS. 3A and 3B are views of a remote switch 195. The remote switch 195 connects to an input jack 130 (see FIG. 1A) on the side of the monitor 100. The remote switch 195 shown in FIGS. 3A and 3B is one of several types of switches (e.g. rocker, plunger type switch (item 196 in FIG. 2A), toggle switch, flip switch, etc.) that can be utilized to perform the function of the remote switch 195.

The remote switch 195 is preferably utilized to allow the caregiver to arm (i.e. turn on/off) the monitor 100, in lieu of manipulating the local on/off switch 145.

Alternatively, the internal circuit of the monitor 100 can be configured to utilize the remote switch 195 to silence an alarm that the monitor 100 is sounding, leaving the monitor armed after the alarm is silenced. In this configuration, it is preferable for the internal circuit to include first and second switches (not shown) that are activated when the top 150 and bottom 160 are separated and pushed together, respectively. After the remote switch 195 is used to silence the alarm, the subsequent closing of the second switch (which occurs when the chair is occupied) resets the alarm monitor and allows the alarm to again sound after the occupant occupies and then leaves the chair. This configuration eliminates the need for the caregiver to have to remember to turn the alarm “on”, i.e. arm the alarm, again.

Adjustable attachment means, such as the Velcro-connected strap 199 shown, is provided to allow the caregiver to adjust the position of the remote switch 195 on the chair. The adjustable attachment means allows the caregiver to conveniently access the remote switch 195, avoiding the need for the caregiver to blindly reach beneath the chair to either turn the alarm on/off or to silence the alarm. The adjustable attachment means also allows the caregiver to move the remote switch 195 out of the range of the occupant's reach.

The circuitry of the monitor 100 preferably includes a delay means (e.g. a dead-band circuit) to avoid the alarm being sounding if the occupant merely shifts his or her weight in the seat 210. A preset or selectable dead-band will reduce nuisance alarms.

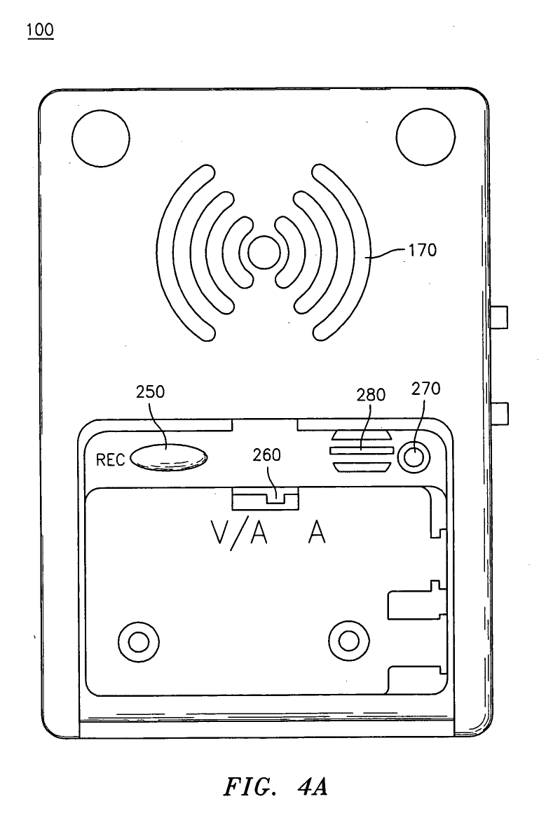

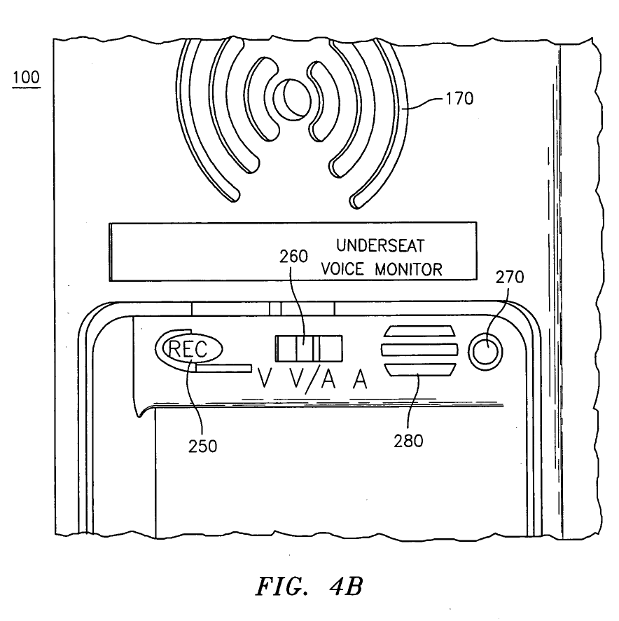

FIGS. 4a and 4b provide close-up views of the monitor underside with the battery compartment cover 180 removed. A record (“Rec”) button 250 is preferably provided to allow the caregiver to record a unique voice alarm. A recording indicator 270 is provided by an LED (light emitting diode) to inform the caregiver when the unique voice alarm is being recorded.

As shown in FIG. 4a, an alarm type switch 260 (“V/A A”) is provided to allow the caregiver to select the type of alarm (i.e. either a buzzer or other predetermined sound or a unique voice alarm) that will issue from the monitor 100. FIG. 4b shows a “V V/A A” alarm type selection switch which allows the caregiver to select from among a voice alarm, a combination of voice and buzzer alarm, or a buzzer alarm that will issue from the monitor 100.

FIGS. 5a and 5b show a preferred arrangement of controls on the side of the monitor 100, in which the local on/off switch 145, a low battery indicator (“low batt.”)(preferably by blinking LED), and a chime/alarm selector switch 149 (“CH/AL”) are provided. The chime/alarm selector switch 149 allows the caregiver to elect the type of predetermined sound that will be utilized for the alarm.

While the invention has been shown and described with reference to certain preferred embodiments thereof, those of skill in the art will recognize that various changes in form and detail to the above embodiments may be made therein without departing from the spirit and scope of the invention, as defined by the appended claims.

1. An apparatus for providing an alarm when a wheelchair occupant leaves a seat of the wheelchair, comprising:
a monitor to be positioned beneath the seat when the monitor is secured to the wheelchair via opposing edges of the monitor;
a top of the monitor for contacting an underside of the seat when the monitor is secured to the wheelchair; and
an internal spring for pushing the top of the monitor apart from a bottom of the monitor, wherein a spring force of the internal spring is overcome by the occupant occupying the seat and the alarm is provided when the occupant leaves the seat.

2. The apparatus of claim 1, further comprising:
an internal circuit having a switch held open by the spring force when the occupant is seated and that provides a signal when the switch closes when the occupant rises from the seat;
a speaker for outputting the alarm upon receipt of the signal from the internal circuit;
a local on/off switch to turn the monitor on/off; and
an input jack for connecting a remote switch.

3. The apparatus of claim 2, further comprising:
adjustable attachment means for attaching the remote switch to the wheelchair, to allow the remote switch to be moved out of the occupant's reach.

4. The apparatus of claim 2, wherein the alarm can be silenced by operation of the remote switch, and a subsequent occupying of the wheelchair will reset the monitor, thereby allowing the alarm to again sound after the occupant leaves the chair, without having to arm the alarm again.

5. The apparatus of claim 3, wherein the remote switch is one of a rocker type switch, a plunger type switch, a toggle switch or a flip switch.

6. The apparatus of claim 1, wherein the top of the monitor slightly pushes against the underside of the seat when the monitor is secured to the wheelchair.

7. The apparatus of claim 1, wherein the monitor is secured to the wheelchair via straps threaded through respective openings at opposing edges of the monitor, and the straps are adjustable in length to allow the monitor to be attached to different size wheelchairs.

8. The apparatus of claim 2, wherein the internal circuit delays output of the signal by a preset or selectable dead-band to reduce nuisance alarms caused by a shift in weight by the occupant.

9. The apparatus of claim 2, wherein the internal circuit further comprises:
a unique voice alarm; and
a recording indicator provided by an Light Emitting Diode (LED) for informing when the unique voice alarm is being recorded.

10. An apparatus for providing an alarm when a wheelchair occupant leaves a seat of the wheelchair, comprising:
a monitor to be positioned within the seat when the monitor is secured to the wheelchair via opposing edges of the monitor;
a top of the monitor for contacting an underside of the seat when the monitor is secured to the wheelchair; and
an internal spring for pushing the top of the monitor apart from a bottom of the monitor, wherein a spring force of the internal spring is overcome by the occupant occupying the seat and the alarm is provided when the occupant leaves the seat.

11. The apparatus of claim 10, further comprising:
an internal circuit having a switch held open by the spring force when the occupant is seated and that provides a signal when the switch closes when the occupant rises from the seat;
a speaker for outputting the alarm upon receipt of the signal from the internal circuit;
a local on/off switch to turn the monitor on/off; and
an input jack for connecting a remote switch that is attachable to multiple locations on the wheelchair, to allow the remote switch to be moved out of the occupant's reach.

12. The apparatus of claim 11, wherein the alarm can be silenced by operation of the remote switch, and a subsequent occupying of the wheelchair will reset the monitor, thereby allowing the alarm to again sound after the occupant leaves the chair, without having to arm the alarm again.

13. The apparatus of claim 11, wherein the remote switch is one of a rocker type switch, a plunger type switch, a toggle switch or a flip switch.

14. The apparatus of claim 10, wherein the monitor is secured to the wheelchair via straps threaded through respective openings at opposing edges of the monitor, and the straps are adjustable in length to allow the monitor to be attached to different size wheelchairs.

15. The apparatus of claim 11, wherein the internal circuit delays output of the signal by a preset or selectable dead-band to reduce nuisance alarms caused by a shift in weight by the occupant.

16. The apparatus of claim 11, wherein the internal circuit further comprises:
a unique voice alarm; and
a recording indicator provided by an Light Emitting Diode (LED) for informing when the unique voice alarm is being recorded.

17. An alarm for use with an invalid chair comprising:
a monitor to be positioned beneath or within a seat of the invalid chair when the monitor is secured to a frame of the invalid chair via opposing edges of the monitor;
a top of the monitor for contacting the seat when the monitor is secured to the frame of the chair; and
an internal spring for pushing the top of the monitor apart from a bottom of the monitor, wherein a spring force of the internal spring is overcome by the occupant occupying the seat and the alarm is provided when the occupant leaves the seat.

18. The alarm of claim 17, further comprising:
an internal circuit having a switch held open by the spring force when the occupant is seated and that provides a signal when the switch closes when the occupant rises from the seat;
a speaker for outputting the alarm upon receipt of the signal from the internal circuit;
a local on/off switch to turn the monitor on/off;
an input jack for connecting a remote switch attachable to multiple locations on the chair, to allow the remote switch to be moved out of the occupant's reach;
a unique voice alarm; and
a recording indicator provided by an Light Emitting Diode (LED) for informing when the unique voice alarm is being recorded.

19. The alarm of claim 18, wherein the alarm can be silenced by operation of the remote switch, and a subsequent occupying of the chair will reset the monitor, thereby allowing the alarm to again sound after the occupant leaves the chair, without having to arm the alarm again.

20. The alarm of claim 18, wherein the remote switch is one of a rocker type switch, a plunger type switch, a toggle switch or a flip switch.

21. The alarm of claim 18, wherein the monitor is secured via straps threaded through respective openings at opposing edges of the monitor, and the straps are adjustable in length to allow the monitor to be attached to different size chairs.
